(19) United States
(12) Patent Application Publication
(10) Pub. No.: US 2018/0287943 A1
(43) Pub. Date: Oct. 4, 2018

(54) Combining Multiple Data Streams at a Receiver for QoS Balance in Asymmetric Communications

(71) Applicant: Microsoft Technology Licensing, LLC, Redmond, WA (US)

(72) Inventor: Amer Hassan, Kirkland, WA (US)

(73) Assignee: Microsoft Technology Licensing, LLC, Redmond, WA (US)

(21) Appl. No.: 15/476,917

(22) Filed: Mar. 31, 2017

(51) Int. Cl. H04L 12/801; G06F 17/30; G06F 7/14; G06F 9/50; G06F 15/173; H04N 21/2383; G06F 9/38

(52) U.S. Cl. CPC H04L 47/10; G06F 17/30516; G06F 7/14; G06F 9/3851; G06F 15/17393; H04N 21/2383; G06F 9/5061

(57) ABSTRACT

A receiver for combining multiple data streams at a destination device, where at least one of the multiple data streams may be a redundant data stream sent intermittently to a destination device. The redundant data stream may be sent intermittently depending on the availability of resources available to a source device. Based on monitoring of quality of service (QoS) parameters of an original data stream on the uplink, a base station functioning as an auxiliary receiver may be intermittently activated to intercept the data stream as a redundant data stream. The auxiliary receiver may then send the redundant data stream to the destination device to it QoS for the original data stream. The receiver may receive the data stream alone, or receive both of the redundant second data stream and the original data stream simultaneously, on an intermittent basis to improve QoS for the original data stream.

### BACKGROUND

Wireless communication for media applications requires a high quality of service (QoS) for transmissions sent from a source device to a destination device through a network. This requirement holds true for both of the wireless uplink connection from the source device to an eNodeB/access point of the network, and the wireless downlink connection from an eNodeB/access point of the network to the destination wireless device.

It is not uncommon that it may be the uplink connection from the source device to the network that is the limiting factor on performance. For example, performance on the uplink connection may suffer due to the limited transmission power that is available when the source device is a small battery powered portable device, while the downlink connection may be provided abundant eNodeB/access point transmission power. Also, the fact that the eNodeB/access point is a device integrated into the network infrastructure may allow more efficient link management for the downlinks. Most networks, therefore, exhibit unbalanced performance between uplink and downlink.

### SUMMARY

This summary is provided to introduce a selection of concepts in a simplified form that are further described below in the Detailed Description. This summary is not intended to exclusively or exhaustively identify key features or essential features of the claimed subject matter. Nor is it intended as an aid in determining the scope of the claimed subject matter.

The disclosed embodiments include methods, systems, and apparatus for combining multiple data streams at a receiver in a destination device, where at least one of the multiple data streams may be a redundant data stream sent intermittently to the destination device. The redundant data stream may be sent intermittently depending on the availability of uplink resources available to a source device. For example, a source device may be sending a first data stream to a primary base station on an uplink connection Where the first data stream is addressed to the destination device. Based on monitoring of one or more quality of service (QoS) parameters on the uplink connection, a base station functioning as an auxiliary receiver may be activated on an intermittent and unscheduled basis to intercept the data stream as a redundant second data stream. The auxiliary receiver may then send the second data stream to the destination device to improve QoS for the first data stream as received at the destination device. Implementations of the embodiments provide a receiver at the destination device that is able to adaptively receive the first data stream alone, or receive both the redundant second data stream and the first data stream simultaneously, on an intermittent and unscheduled basis, to improve QoS for the first data stream.

In an implementation, a device includes a receiver configured to receive a first data stream from a network, where the first data stream was sent by a source device on an uplink connection to a primary base station, receive a second data stream from the network, where the second data stream comprises the first data stream as intercepted on the uplink at an auxiliary receiver configured in a secondary base station in the network, determine that the second data stream is redundant to at least a portion of the first data stream, combine the first data stream and the second data stream to generate a combined third data stream, and process the third data stream. In one example, the receiver may be configured to determine that the second data stream is redundant to at least a portion of the first data stream by analyzing the source addresses of the first and second data stream, and determining that the first data stream and the second data stream are from the same source device based on the analysis of the source addresses. In another example, the receiver may be configured to determine that the second data stream is redundant to at least a portion of the first data stream by controlling the device to detect that the second data stream includes an indication of redundancy, and determine that the second data stream is a redundant data stream based on the indication. The auxiliary receiver which intercepts the second data stream from the source device may insert the indication in the second data stream.

In an implementation, the receiver may process hits at the network layer to determine that the first and second data streams are from the same source device, combine the first data stream and the second data stream in the network layer using redundancy combination techniques to generate a third data stream, and process the third data stream in an application layer.

In another implementation, the receiver may process bits at an application layer to determine that the first and second data streams are from the same source device, combine the first data stream and the second data stream in the application layer using redundancy combination techniques to generate a third data stream, and process the third data stream in the application layer.

In a further implementation, the receiver may process bits at the network layer to determine that the first and second data streams are from the same source device, combine, based on the determination, the first data stream and the second data stream at the physical/media access control (MAC) layer using redundancy combination techniques to generate a third data stream, and process the third data stream in an application layer.

### BRIEF DESCRIPTION OF THE DRAWINGS

FIG. 1 is a diagram illustrating a system including an example destination device comprising a receiver implemented according to an embodiment of the disclosure;

FIG. 2 is a diagram illustrating the system of FIG. 1 in a second scenario;

FIG. 3A is a flow diagram of example operations performed at the network layer by an example receiver in a destination device;

FIG. 3B is a block diagram of an implementation of functions for combining multiple data streams at the example receiver of FIG. 3A;

FIG. 4A is a flow diagram of example operations performed at the application layer by an example receiver in a destination device;

FIG. 4B is a block diagram of an implementation of functions for combining multiple data streams in the example receiver of FIG. 4A;

FIG. 5A is a flow diagram of example operations performed in the application/network layer and PHY/MAC layer by an example receiver in a destination device;

FIG. 5B is a block diagram of an implementation of functions for combining multiple data streams in the example receiver of FIG. 5A;

FIG. 6 is a flow diagram of example operations performed by another example receiver in a destination device; and,

FIG. 7 is a simplified block diagram showing an example receiver.

### DETAILED DESCRIPTION

The system, method and apparatus will now be described by use of example embodiments. The example embodiments are presented in this disclosure for illustrative purposes, and not intended to be restrictive or limiting on the scope of the disclosure or the claims presented herein.

The technologies and techniques that are described herein provide embodiments of systems, methods and apparatus for combining multiple data streams at a receiver in a destination device, where at least one of the multiple data streams may be a redundant data stream sent intermittently to the destination device.

Use of a receiver according to the embodiments in a destination device provides an advantage in systems in which a redundant data stream may be sent intermittently to the destination device to improve quality of service (QoS), depending on the availability of uplink resources available to a source device. For example, the implementation of the receiver in a destination device allows a first base station in a system to be configured to flexibly operate as an auxiliary receiver for uplink connections from a source device to provide redundant data to a destination device, when the first base station has available bandwidth. The first base station may operate as an auxiliary receiver in a scenario where uplink bandwidth/resources provided to the source device by a second or primary base station are not adequate. When the first base station operates as an auxiliary receiver, the receiver in the destination device receives the redundant data stream from the first base station alone with the original data stream from the second base station. The receiver in the destination device may then combine the redundant data stream with the original data stream to improve the QoS provided by the original data stream. When the first base station is not operating as an auxiliary receiver, the receiver in the destination device receives only the original data stream from the second base station.

Use of the receiver in a destination device provides an environment in which the auxiliary receiver in the first base station need not communicate to the destination device that it is operating as an auxiliary receiver. The receiver in the destination device is able to adapt flexibly to the operation of any base station operating as an auxiliary receiver by adaptively determining if both of the redundant data stream and the original data stream, or only the original data stream are/is being received. When both of the redundant data stream and the original data stream are received at the destination device, the data streams may be combined to improve quality of service (QoS) for the data stream sent from the source device. The receiver in the destination device is able to adaptively receive the original data stream alone, or receive both of the redundant data stream and the original data stream simultaneously, on an intermittent and unscheduled basis, from the auxiliary receiver in the first base station to improve QoS for the first data stream. This allows the first base station operating as the auxiliary receiver to adapt its operation intermittently and on an unscheduled basis, depending on available bandwidth resources at the first base station, on bandwidth requirements of the second base station, and on system needs.

Use of the receiver in a destination device also provides an environment in which the auxiliary receiver in the first base station may be flexibly configured to provide uplink support for a variety of protocols when the uplinks in a system become overloaded and QoS is degraded at one or more destination devices. Using the first base station as at auxiliary receiver allows the resources of the first base station to be utilized to increase QoS at a destination device in situations where the first base station would otherwise be idle and not utilized. In various implementations, the first base station may operate in a primary mode to provide conventional uplink and downlink communications to devices using, for example, any of the IEEE 802.11 Wi-Fi, 3rd Generation Cellular (3G), 4^{th} Generation Cellular (4G), wide band code division multiple access (WCDMA), or Long Term Evolution (LTE) Cellular protocols. Then when operating in auxiliary mode, the first base station may configure itself as an auxiliary receiver as needed to provide uplink support using an appropriate protocol of any of above protocols. The first base station may switch between primary mode and auxiliary mode as resource availability and resource requirements allow, if the resources of the first base station are needed for operation in primary mode, the first base station may switch back to primary mode from auxiliary mode when the first base station has available resources. In the implementations, the receiver in the destination device adapts to use of the first base station as the auxiliary receiver.

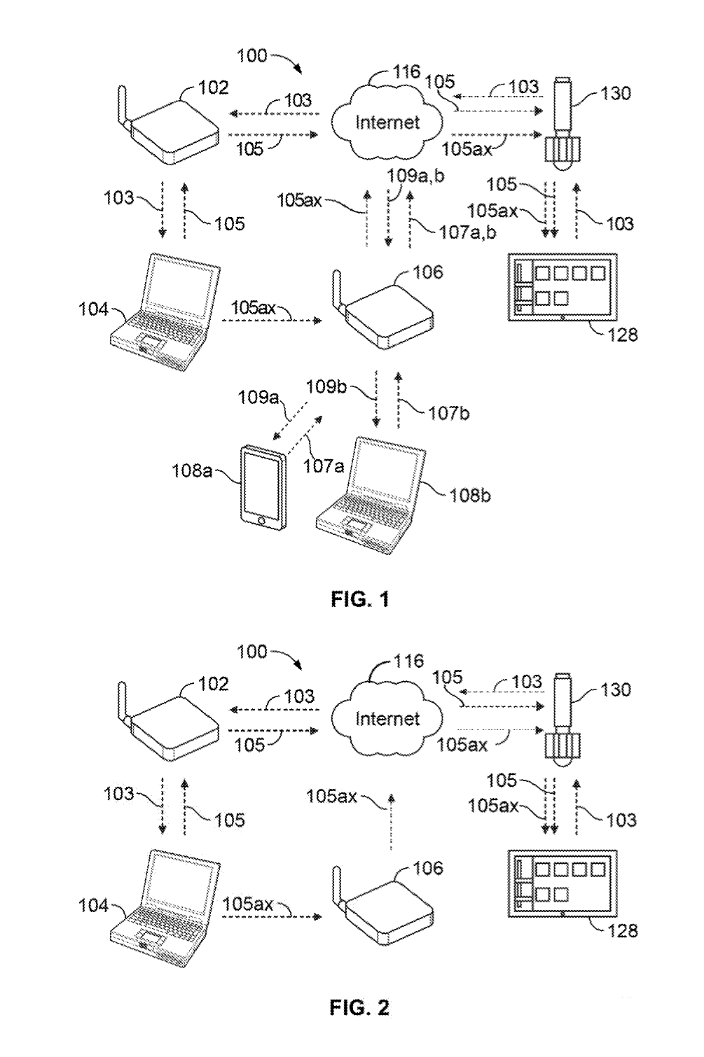

FIG. 1 is a diagram illustrating a system including an example destination device comprising a receiver implemented according to an embodiment of the disclosure. System 100 includes base station 102 and base station 106. In the example implementation of FIG. 1, base station 102 may be implemented as a Wi-Fi access point (AP) and base station 106 may be implemented as a 5G micro-base station with Wi-Fi capability. System 100 also includes base station 130, which may be implemented as a 5G micro-base station. Base stations 102, 106 and 130 may configured to communicate with one another through a network implemented, for example, by communication paths through interact 116. In FIG. 1, device 104 is shown sending an uplink data stream 105 to base station 102 on the uplink (UL) between device 104 and base station 102. Base station 102 then routes data stream 105 through the internet 116 to base station 130 which sends data stream 105 to device 128 on the downlink (DL) between base station 130 and device 128. Device 104 is also shown receiving data stream 103 from base station 102 on the downlink (DL) between base station 102 and device 104. Data stream 103 has originated at device 128 which sends data stream 103 to base station 130 on the uplink (UL) between device 128 and base station 130. Base station 130 then routes data stream 103 through the interact to base station 102 for sending to device 104. In an example, device 104 and device 128 may be communicating data streams for a user application such as a video/voice call application or another multimedia application that uses high data rate transmissions.

In the implementation of FIG. 1, base station 106 may operate as an auxiliary receiver to provide extra data redundancy/QoS for device 102 for data stream 105 when base station 106 has available bandwidth. In this scenario, base station 106 may intercept data stream 105 (as sent to base station 102 on the UL between device 104 and base station 102) as data stream 105ax and forward the intercepted data stream onward to internet 116 as redundant data stream 105ax for routing to base station 130, which then sends data stream 105ax to device 128 on the downlink (DL) between base station 130 and device 128 as redundant data stream 105ax. Device 128 may combine the data streams 105 and 105ax, utilizing the redundant data stream 105ax for more accurate data decoding and better quality of service for the application with which the two din-ices are communicating.

In FIG. 1, the bandwidth available to base station 106 may depend on the resources base station 106 needs for other data traffic. For example, base station 106 may need to carry data traffic for one or more devices, such as devices 108a and 108b on uplinks 107a and 107b, respectively, and downlinks 109a and 109b respectively. Therefore, the ability of base station 106 to provide data stream 105ax as a redundant data stream to data stream 105 to device 128 in the scenario of FIG. 1 may be intermittent, and unpredictable in time, depending on the traffic from devices 108a and 108b.

The term micro base station as used in this specification means a to power base station that covers a relatively small area compared to conventional base stations. For example, while a conventional cellular base station may cover an area of up to 22 kilometers, a micro-base station may use power control to limit the radius of its coverage area. In one application, a micro-base station may provide coverage in an area of 2 kilometers or less (microcell). A micro-base station also includes a base station that provides coverage of an area on the order of 200 meters or less (picocell), or of an area of 10 meters or less (femtocell). Micro-base stations may be used to add network capacity in areas with very dense mobile device usage, such as train stations, and are often deployed temporarily during sporting events and other occasions in which extra capacity is known to be needed at a specific location in advance. Use of micro-base stations with power control implemented in wireless networks makes it easier to prevent interference from nearby cells using the same frequencies. By subdividing cells, and creating more cells to help serve high density areas, a wireless network operator can optimize the use of spectrum and increase capacity.

While implementations of the embodiments are described as using micro-base stations, the embodiments may be implemented in any type of network or system using any type of base station, or combination of types of base stations, when the disclosed techniques may provide an advantage.

Referring now to FIG. 2, FIG. 2 shows system 100 in another scenario in which devices 108a and 108b are no longer communicating through base station 106. In the scenario of FIG. 2, base station 106 may be able to provide data stream 105ax, as a redundant data stream to data stream 105, to device 128 for longer periods of time as compared to the scenario of FIG. 1. Implementations of the embodiments of the disclosure may be utilized in scenarios such as those of FIG. 1 and FIG. 2 to provide a receiver in a device 128 that is able to flexibly receive and process redundant data when the redundant data is sent intermittently and unpredictably.

In order to provide the redundant data stream 105ax to device 128, base station 106 of system 100 may be configured with applications and/or program code that allow it to communicate with other devices in the system to coordinate with and inform the other devices of its operation as an auxiliary receiver. In some implementations, base station 106 may operate transparently as an auxiliary receiver, without other devices in the system being informed of its operation as an auxiliary receiver. Also, device 128 may be configured with applications and/or program code that allow it to detect and process a redundant data stream whenever base station 106 is sending the redundant data stream.

For example, base station 106 may be configured to communicate wirelessly, or through the internet 116, with base station 102 so that base station 102 may send requests for auxiliary bandwidth to base station 106, and base station 106 may respond appropriately to provide data stream 105ax to destination device 128. In other examples, base station 106 may also be configured to communicate with other des ices, such as a network controller in the internet, or with device 104, so that requests for bandwidth may be received from those devices. In these implementations, each of the communicating devices may be equipped with an application that allows each device to be aware of each other's location and/or address in the system, for example an IP address, and send/receive appropriate communication signals. In one implementation, base station 106, may perform registration fur auxiliary receiver operation with other devices, such as base station 102 or a network controller, upon installation/activation of base station 106 in the system 100.

In one example implementation, base station 106 may also function as a conventional 5G micro base station to provide uplink/downlink communications through the internet with any 5G devices that move into the coverage area of base station 106. When there is a light load of 5G devices or no 5G devices in the coverage area of base station 106, and bandwidth resources are available, base station 106 may configure itself to intercept the data stream 105 to provide the extra redundancy for device 102 with data stream 105ax. In another example implementation, base station 106 may function as a dedicated auxiliary receiver for uplink transmissions of devices such as device 104. When in this implementation, if base station 106 has available bandwidth it may intercept uplink data streams transmitted from various devices using various protocols, depending on the devices, to provide data redundancy to the various devices fur uplink transmissions. Depending on the number of devices, the data redundancy may be provided to each device intermittently on a time sharing basis. For example, the available bandwidth of base station 106 may be shared equally on a time scheduled basis, or be shared on a queued basis.

While device 104 is shown as an example laptop and device 128 is shown as an example tablet device, devices 104 and 128 may each be another type of mobile device. For example, each of the devices 104 and 128 may also be alternatively implemented as any other type of device such as, for example, desktop PCs, gaming devices, media devices, smart televisions, home theater systems, smart automobile systems, smart house systems, multimedia cable/television boxes, smart phone accessory devices, tablet devices, tablet accessory devices, personal digital assistants (PDAs), portable media players, smart watches, smart sensors, or industrial control systems. In other example implementations of FIG. 1 and FIG. 2, base station 102 and/or base station 106 may also be configured according to any other wireless interface standard such as 3GPP Wide Band Code Division Multiple Access (WCDMA), 3GPP Long Term Evolution (LTE), or another wireless interface standard. Base station 106 may then be configured to provide auxiliary radio service based on an appropriate protocol of base station 102 that is used on the uplink with device 104.

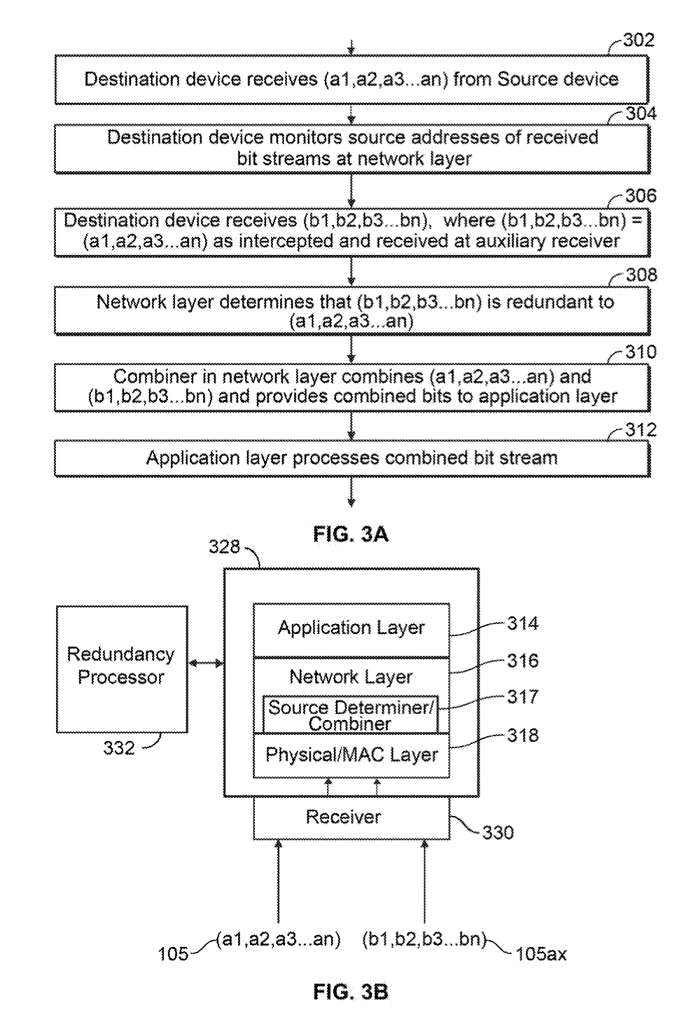

FIG. 3A is a flow diagram of example operations performed at the network layer by an example receiver in a destination device such as device 128 of FIGS. 1 and 2. FIG. 3B is a block diagram of an implementation of functions for combining multiple data streams at an example receiver in the destination device of the process of FIG. 3A. FIG. 3B shows redundancy processor 332, receiver 330, and processing stack 328. Processing stack includes application layer 314, network layer 316, and physical/MAC layer 318. Network layer 316 includes source determiner/combiner 317. The functions of FIG. 3B may be explained with reference to FIGS. 1 and 2, and FIG. 3A.

Referring again to FIG. 3A, the process begins at 302 where device 104 (source device) and device 128 (destination device) initiate a communication session and device 104 sends data stream 105 as hits (a1, a2, a3, . . . , an) to device 128 through base station 102, internet 116, and base station 130. Device 128 receives data stream 105 as bits (a1, a2, a3, . . . , an) at receiver 330. The communication session may be any type of session in which data is exchanged and may also include the sending of data in the opposite direction from device 128 to device 104 as data stream 103.

At 304, as device 128 receives data stream 105 as bits (a1, a2, a3, . . . , an) at receiver 330 and processes data stream 105 in processing stack 328, the processed data stream 105 is provided to application layer 314. Application layer 314 may service the application controlling the communications session with device 104. As device 128 receives and processes data stream 105, redundancy processor 332 controls source determiner/combiner 317 in network layer 117 to monitor the source addresses of data streams received at device 128 in order to determine if any redundant data streams are being, received. At this point in time, only data stream 105 is being received from device 104.

At 306, receiver 330 of device 128 also begins receiving redundant data stream 105ax that comprises bits (b1, b2, b3, . . . , bn) from base station 106 which has begun to operate as an auxiliary receiver. Data stream 105ax comprises the data stream 105 (comprising (a1, a2, a3, . . . , an) sent by device 104 to base station 102), as intercepted by and received at base station 106. At this point in time both of data stream 105 and data stream 105ax are being received from device 104.

At 308, redundancy processor 332 of device 128 controls source determiner/combiner 317 at the network layer 316 to determine that the redundant data stream 105ax comprising bits (b1, b2, b3, . . . , bn) is being received in addition to data stream 105 that comprises bits (a1, a2, a3, . . . , an). Source determiner/combiner 317 may monitor the source addresses of data streams received at device 128 in order to perform the determination at 306.

At 310, source determiner/combiner 317 combines the bits (a1, a2, a3, . . . , an) and (b1, b2, b3, . . . , bn) into a combined data stream using redundancy/error correction/combining techniques and provides the combined data stream to application layer 314. The combining may be done using, for example, selective combining, maximal ration combining, or equal gain combining. Next, at 312, the combined bit streams are then processed at the application layer 314 of device 128.

Operations 302, 304, 306, 308, 310, and 312 of FIG. 3A may then be repeated as device 128 intermittently receives redundant data stream 105ax comprising bits (b1, b2, b3, . . . , bn), in addition to receiving data stream 105 comprising bits (a1, a2, a3, . . . , an). When it is determined that data stream 105ax is being received at 308, operations 310 and 312 will be performed to combine the bits (a1, a2, a3, . . . , an) and (b1, b2, b3, . . . , bn) to increase the QoS associated with the data stream 105 as provided to the application layer. When data stream 105ax is not being received at device 128, device 128 processes the single data stream 105 and provides that processed data stream to the application layer.

The triggering of base station 106 to operate as an auxiliary receiver may be self-initiated by base station 106. In self-initiation mode, base station 106 may determine that it has bandwidth available to provide service as an auxiliary receiver on one or more uplinks. This may happen in the example scenario of FIG. 2 where devices 108a and 108b (shown in the scenario of FIG. 1) are no longer communicating with base station 106 and bandwidth is freed up. Base station 106 may then determine the protocol used by device 104 to send data stream 105 on the uplink. Base station 106 may determine the protocol of device 104 in various ways. In one example, base station 106 may be already configured to operate as an auxiliary receiver using the same protocol as base station 102, for example Wi-Fi, and automatically intercept data stream 105 using this protocol. In another example, base station 106 may scan a frequency range of protocols with which device 104 could be sending uplink data stream 105. Base station 106 may then determine the protocol used by device 104 on the uplink using protocol analysis and configure itself for that protocol by switching to a mode of operation preconfigured for that protocol. In a further example, base station 106 may include a software defined radio (SDR) that may be configured using code for the determined protocol retrieved from a memory/SDR database. When the operation of base station 106 as an auxiliary receiver is self-initiated, the operation of base station 106 may he transparent to device 104, base station 102 and device 128.

In another example, the operation of base station 106 to provide data redundancy to device 104 may be initiated by a request for bandwidth received at base station 106 from base station 102, a request received from device 104, or a request received from a network controller implemented in internet 116. If base station 106 determines it has the requested bandwidth available, it may determine the protocol used by device 102 as described above, or, alternately, it may use protocol information received with the request for bandwidth to configure itself and intercept data stream 105ax using the appropriate protocol.

The determination that base station 106 has available bandwidth and/or resources to use as an auxiliary receiver may be based on monitoring for a selected level of traffic handled by base station 106. If the monitored level of traffic is below the selected level of traffic, base station 106 may determine it has available bandwidth. The selected level of traffic may be a value based on one or more parameters indicative of traffic load on the uplink such as total data throughput requirements, total data rate requirements, QoS, channel usage, etc. The selected level of traffic may be any value ranging from zero to a higher level of traffic and be set by the base station: network operator depending on the capabilities of base station 106. In another example, base station 106 may make the determination by monitoring the number of active connections with wireless devices in the coverage area of base station 106, and if the number of active connections is zero or below a certain number for a time period, base station 106 may determine that it has available bandwidth. In other examples, other parameters related to traffic load may be considered in the determination. For example, the way in which uplink traffic patterns vary by time of day may be considered. In an example of this, during low traffic periods, base station 106 may determine it has available bandwidth based on less stringent requirements for traffic load, or with no requirements related to traffic load.

When operating as an auxiliary receiver, base station 106 may provide data redundancy for one or more uplink data streams. For example, base station 106 may be dedicated to serve as an auxiliary receiver to only device 104 when it has available resources. Alternately, base station 106 may provide data redundancy on an allocated and/or shared basis to multiple devices, such as device 104. In either case, the sending of the redundant data stream 105ax to device 128 may be intermittent and/or unpredictable as to when it occurs in time.

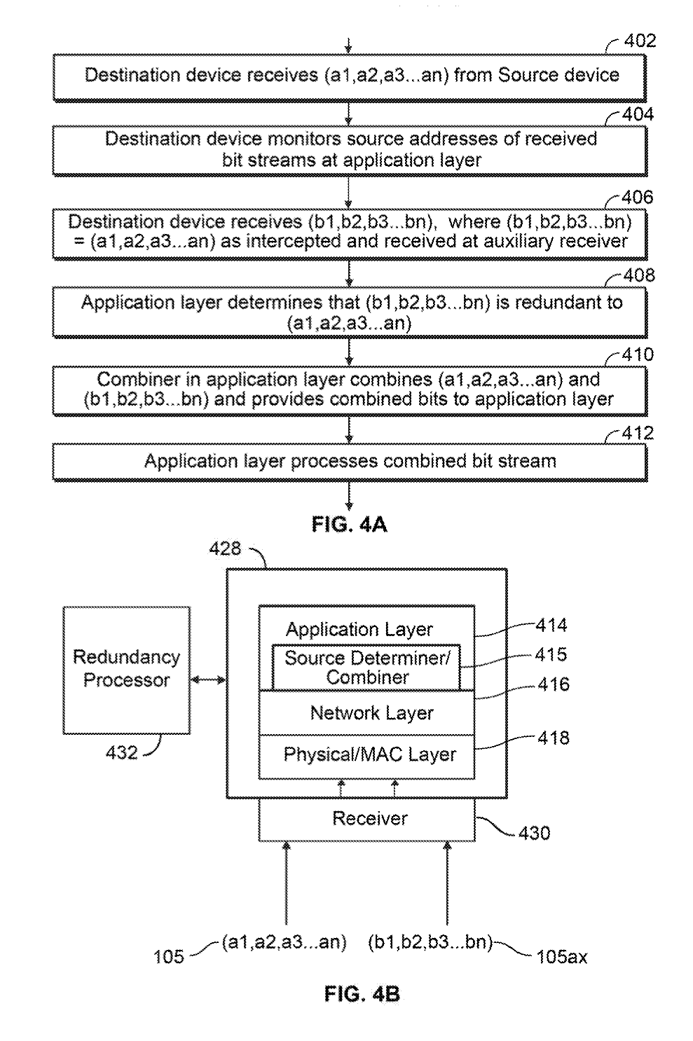

FIG. 4A is flow diagram of example operations performed at the application layer by another example receiver in a destination device. FIG. 4B is a block diagram of an implementation of functions for combining multiple data streams at an example receiver in the destination device of the process of FIG. 4A. FIG. 4B shows redundancy processor 432, receiver 430, and processing stack 428. Processing stack includes application layer 414, network layer 416, and physical/MAC layer 418. Application layer 414 includes source/determiner combiner 415. The functions of redundancy processor 432, receiver 430, processing stack 428, application layer 414, network layer 416, and physical/MAC layer 418, may correspond to the functions of redundancy processor 332, receiver 330, processing stack 328, application layer 314, network layer 316, and physical/MAC layer 318 of FIG. 3B with the exception that source determiner/combiner 415 is implemented in application layer 414. FIG. 4b may be explained with reference to FIGS. 1 and 2, and FIG. 4A.

The example device of FIGS. 4A and 4B may perform operations 402, 404, and 406 of FIG. 4A i a manner similar to operations 302, 304, and 306 of FIG. 3A.

At 408 redundancy processor 432 of device 128 controls source determiner/combiner 415 at the application layer 414 to determine that the redundant data stream 105ax comprising bits (b1, b2, b3, . . . , bn) is being received in addition to data stream 105 that comprises hits (a1, a2, a3, . . . , an). Source determiner/combiner 415 may monitor the source addresses of data streams received at device 128 in order to perform the determination at 406.

At 410, source determiner combiner 415 combines the bits (a1, a2, a3, . . . , an) and (b1, b2, b3, . . . , bn) into a combined data stream using redundancy/error correction/combining techniques. The combining may be done using, for example, selective combining, maximal ration combining, or equal gain combining. Next, at 412, the combined bits streams are then processed at the application layer 414 of device 128.

In the implementation of FIG. 4A and 4B, including source determiner/combiner 415 at the application layer 414 allows device 128 to be flexibly configured to receive and combine multiple data streams according to the disclosed implementations.

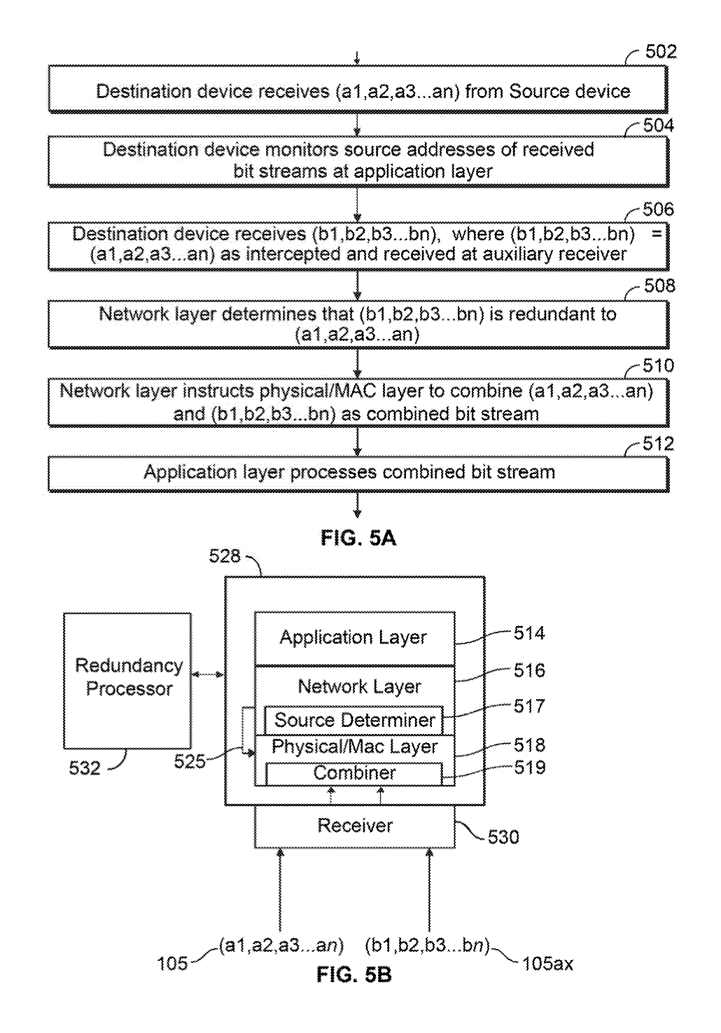

FIG. 5A is flow diagram of example operations performed at the network layer by another example receiver in a destination device. FIG. 5B is a block diagram of an implementation of functions for combining multiple data streams at an example receiver in the destination device of FIG. 5A. FIG. 5B shows redundancy processor 532, receiver 530, and processing stack 528. Processing stack includes application layer 514, network layer 516, physical/MAC layer 518, source determiner 517 in network layer 516, and combiner 519 in physical/MAC layer 518. The functions of redundancy processor 532, receiver 530, processing stack 528, application layer 514, network layer 516, and physical/MAC layer 518, may correspond to the functions of redundancy processor 332, receiver 330, processing stack 328, application layer 315, network layer 316, and physical/MAC layer 318 of FIG. 3B with the exception that source determiner 517 is implemented in network layer 516, and combiner 519 is implemented in physical/MAC application layer 518. FIG. 5B may be explained with reference to FIGS. 1 and 2, and FIG. 5A.

The example device of FIGS. 5A and 5B may perform operations 502, 504, and 506 or FIG. 5A in a mariner similar to operations 302, 304, and 306 of FIG. 3A.

At 508, redundancy processor 532 of device 128 controls source determiner 517 at the network layer 516 to determine that the redundant data stream 105ax comprising bits (b1, b2, b3, . . . , bn) is being received in addition to data stream 105 that comprises bits (a1, a2, a3, . . . , an). Source determiner 517 may monitor the source addresses of data streams received at device 128 in order to perform the determination at 508. Source determiner 517 may provide this information to combiner 519 in physical/MAC layer 518 through link 525.

At 510, combiner 519 combines the bits (a1, a2, a3, . . . , an) and (b1, b2, b3, . . . , bn) into a combined data stream using redundancy/error correction/combining techniques. The combining may be done using, for example, selective combining, maximal ration combining, or equal gain combining. Next, at 512, the combined bits streams are then processed through stack 528 of device 128. In an alternative implementation, source determiner 571 may be configured in application layer 514, instead of network layer 517, and provide the results of the determination at 508 to combiner 519 in the physical/MAC layer 518.

In other implementations, device 128 nay be configured to determine that data stream 105 and redundant data stream 105ax are being received, and may be combined, using other methods. For example, base station 106 may be configured to insert an indication in data stream 105ax that indicates that data stream 105ax is a redundant data stream sent by base station 106 functioning as an auxiliary receiver.

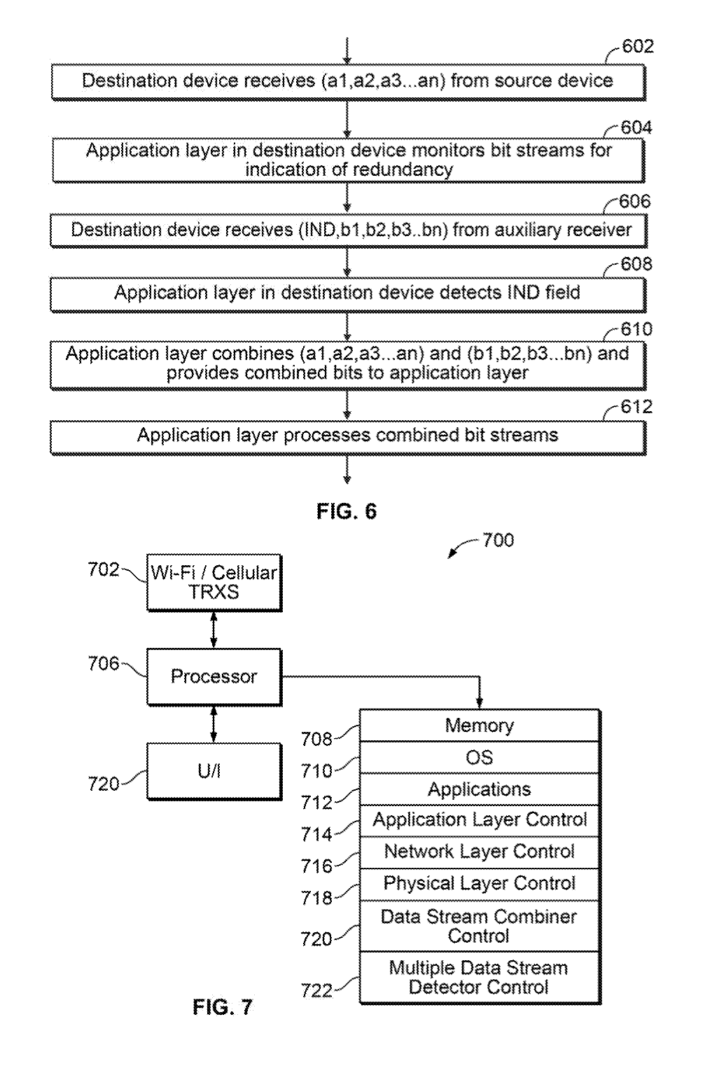

FIG. 6 is a flow diagram of example operations performed by an example receiver in a destination device according to another implementation. FIG. 6 may be explained with reference to FIGS. 1 and 2.

The process begins at 602 where device 102 (source device) and device 128 (destination device) initiate a communication session and device 104 sends data stream 105 as bits (a1, a2, a3, . . . , an) to device 128 through base station 102, internet 116, and base station 130. Device 128 receives data stream 105 as bits (a1, a2, a3, . . . , an). The communication session may be any type of session in which data is exchanged and may also include the sending of data from device 128 to device 104 as data stream 103.

At 604, as device 128 receives data stream 105 as bits (a1, a2, a3, . . . , an) at receiver 330 and processes data stream 105, the processed data stream 105 is provided to an application layer of dewier 128. The application layer may is an application controlling the communications session with device 104. As device 128 receives and processes data stream 105, device 128 monitors the data stream bits received at device 128 in for an indication of redundancy to determine if an redundant data streams are being received. At this period in time only data stream 105 is being received from device 104 and no indication of redundancy is found in the monitored data stream 105.

At 606, device 128 also begins receiving redundant data stream 105ax that comprises bits (b1, b2, b3, . . . , bn) from base station 106 which has begun to operate as an auxiliary receiver. Data stream 105ax comprises the data stream 105, comprising (a1, a2, a3, . . . , an) sent by device 104 to base station 102, as intercepted and received by base station 106. At this period in time both of data stream 105 and data stream 105ax are being received from device 102 at device 128. In the implementation of FIG. 6, base station 106 may insert an indication of redundancy into bits (b1, b2, b3, . . . , bn) of data stream 105a. For example, base station 106 may insert one or more bits as an IND field in (b1, b2, b3, . . . , bn) and send the data stream 105ax as bits (IND, b1, b2, b3, . . . , bn) in order to indicate that data stream 105ax is a redundant data stream.

At 608, device 128 determines that the redundant data stream 105ax comprising bits (IND, b1, b2, b3, . . . , bn) is being received in addition to data stream 105 that comprises bits (a1, a2, a3, . . . , an). Device 128 may monitor the bits m the data streams at the application layer to detest the IND field bits in data stream 105ax in order to perform the determination at 608.

At 610, device 128 combines the bits (a1, a2, a3, . . . , an) and (b1, b2, b3, . . . , bn) into a combined data stream at the application layer using redundancy/error correction/combining techniques. The combining array be done using, for example, selective combining, maximal ration combining, or equal gain combining. Next, at 612, the combined bits streams are then processed at the application layer of device 128.

Operations 602, 604, 606, 608, 610, and 612 of FIG. 6 may then be repeated as device 128 intermittently receives redundant data stream 105ax comprising bits (IND, b1, b2, b3, . . . , bn) in addition to receiving data stream 105 comprising bits (a1, a2, a3, . . . , an). When it is determined that data stream 105ax is being, received, operations 610 and 612 will be performed to combine the bits (a1, a2, a3, . . . , an) and (b1, b2, b3, . . . , bn) to increase the QoS associated with the data stream 105 as provided to the application layer. When data stream 105ax is not being received at device 128, device 128 processes the single data stream 105 and provides that processed data stream to the application layer.

Referring now to FIG. 7, therein is a simplified block diagram of an example device 700 which may be implemented to receive a data stream and an intermittent redundant version of the data stream. Device 700 represents an example implementation of destination device 128 of FIGS. 1 and 2. Device 700 includes processor 706, Wi-Fi/Cellular transceivers 702, user interface (UI) 720, and memory/storage 708 that includes code and programs/instructions tar applications 712, application layer control 714, network layer control 716, physical/MAC layer control 718, data stream combiner control 720, and redundant data stream detector control 722. Memory/storage 708 also includes code and programs/instructions for operating system (OS) 710 that control overall operation of device 700. In various implementations, execution of the code and programs/instructions for application layer control 714, network layer control 716, physical/MAC laser control 718, data stream combiner control 720, and redundant data strewn detector control 722 causes processor 708 to implement operations that cause device 700 to operate as destination device according to the processes of FIGS. 3A, 4A, 5A, and 6.

The example embodiments disclosed herein may be described in the general context of processor-executable code or instructions stored on memory that may comprise one or more computer readable storage media (e.g., tangible non-transitory computer-readable storage media such as memory 708). As should be readily understood, the terms “computer-readable storage media” or “non-transitory computer-readable media” include the media for storing of data, code and program instructions, such as memory 708, and do not include portions of the media for storing transitory propagated or modulated data communication signals.

While the functionality disclosed herein has been described by illustrative example using descriptions of the various components and devices of embodiments by referring to functional blocks and processors or processing units, controllers, and memory including instructions and code, the functions and processes of the embodiments may be implemented and performed using any type of processor, circuit, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICS), application specific standard products (ASSPs), system-on-a-chip systems (SOCs), complex programmable logic devices (CPLDs) etc. Use of the term processor or processing unit in this disclosure is mean to include all such implementations.

The disclosed implementations include a device comprising a receiver, one or more processors in communication with the receiver, and memory in communication with the one or more processors, the memory comprising code that, when executed, causes the one or more processors to control the device to receive a first data stream from a network, receive a second data stream from the network determine that the second data stream is redundant to at least a portion of the first data stream, combine the first data stream and the second data stream to generate a third data stream, and, provide the third data stream for processing. The code may be further executable to cause the one or more processors to control the device to determine that the second data stream is redundant b controlling the device to analyze a source address of the second data stream, and determine that the first data stream and the second data stream are from a same source device based on the analysis of the source address. The code may be further executable to cause the one or more processors to control the device to combine the first data stream and the second data strewn by controlling the device to determine the at least a portion of the first data stream to which the second data stream is redundant, and combine the at least a portion of the first data stream and the second data stream based on the redundancy provided by the second data stream to generate the third data stream. The code may be further executable to cause the one or more processors to control the device to determine the at least a portion of the first data stream to which the second data stream is redundant by controlling the device to detect that the second data stream includes an indication, and determine the at least a portion of the first data stream to which the second data stream is a redundant based on the indication. The code is further executable to cause the one or more processors to control the device to determine that the second data stream is redundant by controlling the device to detect that the second data stream includes an indication of redundancy. The indication may be inserted in the second data stream by an auxiliary receiver that receives the second data stream from the source device. The code, when executed, may cause the one or more processors to implement at least a network layer and an application layer, and control the device to determine that the second data stream is redundant at the network layer, combine the first data stream and the second data stream in the network layer to generate the third data stream, and provide the third data stream for processing in the application layer. The code, when executed, may cause the one or more processors to implement at least an application layer, and control the device to determine that the second data stream is redundant at the application layer, combine the first data stream and the second data stream at the application layer to generate the third data stream at the application layer, and provide the third data stream for processing in the application layer. The code, when executed, may cause the one or more processors to implement at least a physical/MAC layer, a network layer and an application layer, and control the device to determine that the second data stream is redundant at the network layer, combine the first data stream and the second data stream at the physical/MAC layer to generate the third data stream, and provide the third data stream for processing in the application layer. The code, when executed, may cause the one or more processors to implement at least a physical/MAC layer and an application layer, and controls the device to determine that the second data stream is redundant at the application layer, combine the first data stream and the second data stream at the physical/MAC layer to generate the third data stream, and provide the third data stream tear processing in the application layer.

The disclosed implementations further include a device comprising a receiver, one or more processors in communication with the receiver, and memory in communication with the one or more processors, the memory comprising code that, when executed, causes the one or more processors to control the device to receive a first data stream, provide the first data stream for use in one or more functions in the device, receive a second data stream, determine that the second data stream is a redundant version of at least a portion of the first data stream, combine the at least a portion of the first data stream and the second data stream to generate a third data stream, and provide the third data stream for use in the one or more functions in the device. The code may be further executable to cause the one or more processors to control the device to determine that the second data stream is a redundant version of the at least a portion of the first data stream by further controlling the device to analyze the source addresses of the first and second data streams, and determine that the first data stream and the second data stream are from the same source device based on the analysis of the source addresses. The at least a portion of the first data stream may comprise a first portion of the first data stream, and the code may be further executable to cause the one or more processors to further control the device to receive the first portion of the first data stream during each of a first plurality of periods, receive a second portion of the first data stream during each of a second plurality of periods, receive the second data stream during each of the first plurality of time periods, generate a third data stream from the second portion of the first data stream during each of the second plurality of time periods, combine the first portion of the first data stream and the second data stream to generate the third data stream during each of the first plurality of time periods, and provide the third data stream for use in the one or more functions at the device. The code, when executed, may cause the one or more processors to implement at least a network layer and an application layer, and control the device to determine that the second data stream is a redundant version of the at least a portion of the first data stream at the network layer, combine the at least a portion of the first data stream and the second data stream at the network layer to generate the third data stream, and, provide the third data stream for use at the application layer. The code, when executed, may cause the one or more processors to implement at least an application layer, and control the device to determine that the second data stream is a redundant version of the at least a portion of the first data stream at the application layer, combine the at least a portion of the first data stream and the second data stream at the application layer to generate the third data stream, and, provide the third data stream for use at the application layer. The code, when executed, may cause the one or more processors to implement at least a physical/MAC layer, a network layer and an application layer, and control the device to determine that the second data stream is a redundant version of the at least a portion of the first data stream at the network layer, combine the at least a portion of the first data stream and the second data stream at the physical/MAC layer to generate the third data stream, and, provide the third data stream for use at the application layer.

The disclosed implementations further include a device comprising a receiver, one or more processors in communication with the receiver, and memory in communication with the one or more processors, the memory comprising rode that, when executed, causes the one or more processors to control the device to receive a first data stream including a first set of data, intermittently receive a second data stream including a second set of data redundant to at least a portion of the first data, determine if both of the first data stream and the second data stream are being received at the device, and, if both of the first data stream and the second data stream are being received, combine the first and second data stream to generate a third data stream and provide the third data stream for use in one or more functions, or, if only the first data stream is being received, provide the first data stream for use in the one or more functions. The code may be further executable to cause the one or more processors to control the device to determine if both of the first data stream and the second data stream are being received at an application layer. The code may be further executable to cause the one or more processors to control the device to determine if both of the first data stream and the second data stream are being received by analyzing the source addresses of the first and second data streams and determining if the first data stream and the second data stream are from a same source device. The code may be further executable to cause the one or more processors to control the device to determine if both of the first data stream and the second data stream are being received by detecting an indication that the second set of data is redundant to the first set of data.

Although the subject matter has been described in language specific to structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements arid operations that facilitate the processes, these elements, and operations may be combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A device comprising:
a receiver;
one or more processors in communication with the receiver; and,
memory in communication with the one or mare processors, the memory comprising code that, when executed, causes the one or more processors to control the device to:
receive a first data stream from a network;
receive a second data stream from the network;
determine that the second data stream is redundant to at least a portion of the first data stream;
combine the first data stream and the second data stream to generate a third data stream; and,
provide the third data stream for processing.

2. The device of claim 1, wherein the code is further executable to cause the one or more processors to control the device to determine that the second data stream is redundant by controlling the device to:
analyze a source address of the second data stream; and,
determine that the first data stream and the second data stream are from a same source device based on the analysis of the source address.

3. The device of claim 1, wherein the code is further executable to cause the one or more processors to control the device to combine the first data stream and the second data stream by controlling the device to:
determine the at least a portion of the first data stream to which the second data stream is redundant;
and,
combine the at least a portion of the first data stream and the second data stream based on the redundancy provided by the second data stream to generate the third data stream.

4. The device of claim 3, wherein the code is further executable to cause the one or more processors to control the device to determine the at least a portion of the first data stream to which the second data stream is redundant by controlling the device to:
detect that the second data stream includes an indication; and,
determine the at least a portion of the first data stream to which the second data is a redundant based on the indication.

5. The device of claim 1, wherein the code is further executable to cause the one or more processors to control the device to determine that the second data stream is redundant by controlling the device to detect that the second data stream includes an indication of redundancy.

6. The device of claim 5, wherein the indication is inserted in the second data stream by an auxiliary receiver that receives the second data stream from the source device.

7. The device of claim 1, wherein the code, when executed, causes the one or more processors to implement at least a network layer and an application layer, and controls the device to determine that the second data stream is redundant at the network layer, combine the first data stream and the second data stream in the network layer to generate the third data stream, and provide the third data stream for processing in the application layer.

8. The device of claim 1, wherein the code, when executed, causes the one or more processors to implement at least an application layer, and controls the device to determine that the second data stream is redundant at the application layer, combine the first data stream and the second data stream at the application layer to generate the third data stream at the application layer, and provide the third data stream for processing in the application layer.

9. The device of claim 1, wherein the code, when executed, causes the one or more processors to implement at least a physical/MAC layer, a network layer and an application layer, and controls the device to determine that the second data stream is redundant at the network layer, combine the first data stream and the second data stream at the physical/MAC layer to generate the third data stream, and provide the third data stream for processing in the application layer.

10. The device of claim 1, wherein the code, when executed, causes the one or more processors to implement at least a physical/MAC layer and an application layer, and controls the device to determine that the second data stream is redundant at the application layer, combine the first data stream and the second data stream at the physical/MAC layer to generate the third data stream, and provide the third data stream for processing in the application layer.

11. A device comprising:
a receiver;
one or more processors in communication with the receiver; and,
memory in communication with the one or more processors, the memory comprising code that, when executed, causes the one or more processors to control the device to:
receive a first data stream;
provide the first data stream for use in one or more functions in the device;
receive a second data stream;
determine that the second data stream is a redundant version of at least a portion of the first data stream;
combine the at least a portion of the first data stream and the second data stream to generate a third data stream; and,
provide the third data stream for use in the one or more functions in the device.

12. The device of claim 11, wherein the code is further executable to cause the one or more processors to control the device to determine that the second data stream is a redundant version of the at least a portion of the first data stream by further controlling the device to:
analyze the source addresses of the first and second data streams; and,
determine that the first data stream and the second data stream are from the same source device based on the analysis of the source addresses.

13. The device of claim 11, wherein the at least a portion of the first data stream comprises a first portion of the first data stream, and the code is further executable to cause the one or more processors to further control the device to:
receive the first portion of the first data stream during each of a first plurality of periods;
receive a second portion of the first data stream during each of a second plurality of periods;
receive the second data stream during each of the first plurality of time periods;
generate a third data stream from the second portion of the first data stream during each of the second plurality of time periods;
combine the first portion of the first data stream and the second data stream to generate the third data stream during each of the first plurality of time periods; and,
provide the third data stream for use in the one or more functions at the device.

14. The device of claim 11, wherein the code, when executed, causes the one or more processors to implement at least a network layer and an application layer, and controls the device to determine that the second data stream is a redundant version of the at least a portion of the first data stream at the network layer, combine the at least a portion of the first data stream and the second data stream at the network layer to generate the third data stream, and, provide the third data stream for use at the application layer.

15. The device of claim 11, wherein the code, when executed, causes the one or more processors to implement at least an application layer, and controls the device to determine that the second data stream is a redundant version of the at least a portion of the first data stream at the application layer, combine the at least a portion of the first data stream and the second data stream at the application layer to generate the third data stream, and, provide the third data stream for use at the application layer.

16. The device of claim 11, wherein the code, when executed, causes the one or more processors to implement at least a physical/MAC layer, a net layer and an application layer, and controls the device to determine that the second data stream is a redundant version of the at least a portion of the first data stream at the network layer, combine the at least a portion of the first data stream and the second data stream at the physical/MAC layer to generate the third data stream, and, provide the third data stream for use at the application layer.

17. A device comprising:
a receiver;
one or more processors in communication with the receiver; and,
memory in communication with the one or more processors, the memory comprising code that, when executed, causes the one or more processors to control the device to:
receive a first data stream including a first set of data;
intermittently receive a second data stream including a second set of data redundant to at least a portion of the first data;
determine if both of the first data stream and the second data stream are being received at the device;
and, if both of the first data stream and the second data stream are being received:
combine the first and second data stream to generate a third data stream and provide the third data stream for use in one or more functions;
or, if only the first data stream is being received:
provide the first data stream for use in the one or more functions.

18. The device of claim 17, wherein the code is further executable to cause the one or more processors to control the device to determine if both of the first data stream and the second data stream are being received at an application layer.

19. The device of claim 17, wherein the code is further executable to cause the one or more processors to control the device to determine if both of the first data stream and the second data stream are being received by analyzing the source addresses of the first and second data streams and determining if the first data stream and the second data stream are from a same source device.

20. The device of claim 17, wherein the code is further executable to cause the one or more processors to control the device to determine if both of the first data stream and the second data stream are being received by detecting an indication that the second set of data is redundant to the first set of data.
